(19) United States
(12) Patent Application Publication
(10) Pub. No.: US 2007/0270517 A1
(43) Pub. Date: Nov. 22, 2007

(54) Mixtures Containing 1,1,1,3,3-Pentafluorobutane and 1,1,1,2,3,3,3-Heptafluoropropane

(75) Inventors: Lothar Zipfel, Laatzen (DE); Karsten Boerner, Sehnde (DE); Dierk-Ingolf Recke, Wunstorf (DE)

Correspondence Address: CROWELL & MORING LLP;INTELLECTUAL PROPERTY GROUP, P.O. BOX 14300, WASHINGTON, DC, 20044-4300, US

(73) Assignee: SOLVAY FLUOR und DERIVATED GmbH, Hannover (DE)

(21) Appl. No.: 11/835,083

(22) Filed: Aug. 7, 2007

Related U.S. Application Data
(63) Continuation of application No. 10/901,430, filed on Jul. 29, 2004.
Application No. 10/901,430 is a continuation of application No. PCT/EP02/13344, filed on Nov. 27, 2002.

(30) Foreign Application Priority Data
Jan. 30, 2002 (DE) DE 102 03 779.5

(51) Int. Cl. B01F 3/04; C08G 18/48; C08J 9/06

(52) U.S. Cl. 521/98; 516/12; 521/131

(57) ABSTRACT

Blowing-agent mixtures containing HFC-365mfc, HFC-227ea and one or both of 1,1,1,3,3-pentafluoropropane and 1,1,1,2-tetrafluoroethane are disclosed; as well as non-combustible polyether polyol and/or polyester polyol premixes for producing foamed products, in particular polyurethane foams.

### CROSS REFERENCE TO RELATED APPLICATIONS

This application is a continuation of co-pending application Ser. No. 10/901,430, filed Jul. 29, 2004, which in turn was a continuation of international application no. PCT/EP02/13344, filed Nov. 27, 2002, designating the United States of America, and published in German as WO 03/064508, the entire disclosure of which is incorporated herein by reference. Priority is claimed based on Federal Republic of Germany patent application no. DE 102 03 779.5, filed Jan. 30, 2002.

### BACKGROUND OF THE INVENTION

The present invention relates to mixtures containing 1,1,1,3,3-pentafluorobutane (R-365mfc) and at least two further fluorocarbons and their use in the production of foamed plastics.

It is already known to use partially fluorinated hydrocarbons as blowing gases for the production of foamed plastics.

International patent application WO 98/27145 discloses the use of blowing-agent mixtures which contain 1,1,1,3,3-pentafluorobutane and further fluorocarbon compounds and optionally further blowing agents such as carbon dioxide, in the context of the production of foams.

### SUMMARY OF THE INVENTION

It is an object of the present invention to provide improved blowing agent mixtures.

Another object of the invention is to provide blowing agent mixtures with better flashpoints.

A further object of the invention is to provide blowing agent mixtures with which foamed plastics with advantageous qualities can be produced in a simpler manner.

These and other objects are achieved in accordance with the present invention by providing a blowing-agent mixture comprising:
A) 1,1,1,3,3-pentafluorobutane;
B) 1,1,1,2,3,3,3-heptafluoropropane, and
C) at least one of 1,1,1,2-tetrafluoroethane and 1,1,1,3,3-pentafluoropropane,
   with the following provisos:
a) per 100 parts by weight of the blowing-agent mixture, 65 to 85 parts by weight are allotted to the total of constituents A) and B);
b) per 100 parts by weight of the total of the constituents A) and B) mentioned under a), 80 to 95 parts by weight are allotted to 1,1,1,3,3-pentafluorobutane, and the remainder of the total of A) and B) is 1,1,1,2,3,3,3-heptafluoropropane, and
c) per 100 parts by weight of the blowing-agent mixture, at least 15 parts by weight are allotted to constituent C).

Blowing-agent mixtures according to the invention which can be used as blowing gas for the production of foamed synthetic resin materials comprise or consist of:
A) 1,1,1,3,3-pentafluorobutane and
B) 1,1,1,2,3,3,3-heptafluoropropane and
C) 1,1,1,2-tetrafluoroethane and/or 1,1,1,3,3-pentafluoropropane, with the following provisos:
a) per 100 parts by weight of the blowing-agent mixture, 65 to 85 parts by weight, preferably 75 to 85 parts by weight, are allotted to the total of constituents A) and B);
b) per 100 parts by weight of the total of the constituents A) and B) mentioned under a), with 80 to 95 parts by weight, preferably 83 to 90 parts by weight, being allotted to 1,1,1,3,3-pentafluorobutane, and the remainder of the total of A) and B) is formed by 1,1,1,2,3,3,3-heptafluoropropane; and
c) per 100 parts by weight of the blowing-agent mixture, at least 15 parts by weight are allotted to constituent C).

Preferred blowing-agent mixtures consist of constituents A), B) and C), in which per 100 parts by weight of the blowing-agent mixture 70 to 80 parts by weight are allotted to the total of constituents A) and B) and 20 to 30 parts by weight to constituent C).

1,1,1,3,3-pentafluorobutane lies at the limit of flammability; the mixtures according to the invention are also improved compared with known mixtures with HFC-365mfc with regard to flammability. They are particularly suitable for use as blowing gas for the production of foamed plastics with very good insulation values, but may also be used for other purposes such as for example as refrigerants, solvents or cleaning agents.

Particularly good blowing-agent mixtures consist of 80% by weight of a mixture of 87 parts by weight HFC-365mfc and 13 parts by weight HFC-227ea; the remaining 20% by weight consists of 1,1,1,3,3-pentafluoropropane, HFC-134a or a mixture of both.

The mixtures according to the invention are particularly suitable as blowing gas for the production of foamed synthetic resins (i.e., plastics), for example also by the extrusion process. In this process, the thermoplastic resins containing the blowing agent are extruded directly to form foamed sheets, films or profiles. The synthetic resin material foams immediately after leaving the nozzle. For example, XPS and XPE foamed materials (polystyrene- or polyethylene-based foamed materials, respectively) can be produced.

The mixtures according to the invention are particularly well suited for producing foamed materials based on isocyanates. They are highly suitable in the production of in particular rigid, but also flexible foams based on isocyanate, also for integral foams.

The production of foamed materials based on isocyanates is known. Their production and the base materials usable for this purpose are disclosed, for example, in European patent application no. EP-A-0 381 986; in “Ullmann's Encyclopedia of Industrial Chemistry”, 5th edition, volume A 21, pages 665 to 680; international patent applications WO 92/00345, WO 96/30439 and WO 96/14354, and published German patent application no. DE 44 22 714 A1.

Aliphatic, cycloaliphatic, araliphatic, aromatic and heterocyclic polyisocyanates with, for example, 2 to 4 isocyanate groups may be used as starting materials. They have an aliphatic hydrocarbon radical with up to 18 carbon atoms, a cycloaliphatic hydrocarbon radical with up to 15 carbon atoms, an aromatic hydrocarbon radical with 6 to 15 carbon atoms or an araliphatic hydrocarbon radical with 8 to 15 carbon atoms. Starting materials which are particularly preferred industrially include, for example, 2,4-toluene diisocyanate and 2,6-toluene diisocyanate, diphenylmethane diisocyanate, polymethylene polyphenyl isocyanate and mixtures thereof. Also what are called “modified polyisocyanates”, which contain carbodiimide groups, urethane groups, allophanate groups, isocyanurate groups, urea groups or biuret groups, may be used.

Further starting materials are compounds with at least two hydrogen atoms which are reactive with respect to isocyanates. These may advantageously be compounds with molecular weights of from 400 to 10,000, which preferably contain 2 to 8 hydroxyl groups and furthermore may contain amino groups, thiol groups or carboxyl groups. Polyethers, polyesters, polycarbonates and polyester amides which have 2 to 8 hydroxyl groups are particularly well suited.

Optionally also compounds which serve as chain extension agents or cross-linking agents and preferably have 2 to 8 hydrogen atoms which are reactive with respect to isocyanates may be used as starting materials. Usually such agents have a molecular weight of 32 to 400. Amino groups, thiol groups or carboxyl groups may also be present instead of, or in addition to, hydroxyl groups.

Optionally, further auxiliaries and additives may be jointly used. For example, chemical blowing agents such as water additionally may be used. Catalysts such as tertiary amines, for example dimethylcyclohexylamine, and/or organic metal compounds, for example tin salts of carboxylic acids, can also be used. Surface-active additives such as emulsifiers or foam stabilizers, for example siloxane polyether copolymers, reaction-delaying agents, cell regulators such as paraffins, fatty alcohols or dimethyl-polysiloxanes, pigments, dyes, flameproofing agents such as phosphate esters or phosphonate esters, such as for example tris-chloroisopropyl phosphate, may be used. Furthermore, stabilizers against the effects of ageing and the weather, plasticisers, fillers, dyes, antistatic agents, nucleating agents, pore-regulating substances or biocidal active substances can be used.

Examples of suitable catalysts are described in international patent application WO 96/14354. These include organic amines, aminoalcohols and aminoethers such as morpholine compounds, for example dimethylcyclo-hexylamine, diethanolamine, 2-dimethylaminoethyl-3-dimethylaminopropylether, 2-dimethylaminoethylether, 2,2-dimorpholinodiethylether, N,N-dimethylaminoethylmorpholine and N-dimethylmorpholine. Also organometallic compounds, such as tin, cobalt or iron compounds, for example, can be used as catalysts. Examples of useful catalysts include tin dioctoate, cobalt naphthenate, dibutyltin dilaurate and iron ace to nylacetate.

The blowing agents may be used as such, i.e., without the above-mentioned auxiliaries and additives. According to one embodiment, the blowing agents are used together with one or more of the above auxiliaries and additives. The invention thus also relates to production constituents for producing foamed plastics, which are based on a content of the mixture according to the invention which is effective for foaming as blowing gas and at least one of the above-mentioned auxiliaries and additives. The blowing agent according to the invention is then preferably contained in an amount of from 1 to 35% by weight, and the balance to make up 100% by weight is composed of the auxiliaries and/or additives.

One preferred production constituent is a premix comprising a blowing agent according to the invention and at least one polyester polyol and/or polyether polyol. This embodiment will be described in further detail hereinafter.

It is conventional, in order to produce foams, first to produce what are called premixes from the different feed materials, and the premixes are then reacted with the isocyanate. In order to produce the premixes, polyols or polyethers, blowing agents, catalysts and optionally further additives are mixed together in the required amounts. The foams are then produced by bringing the premix into contact with the isocyanate or isocyanates.

If premixes are produced using the aforementioned blowing-agent mixtures, if a critical amount of blowing agent is exceeded surprisingly it may happen that the entire system has to be classified as combustible owing to the low flashpoint, although the blowing-agent mixture and polyol system per se are not combustible.

Premixes according to the invention contain polyol and also 1 to 35% by weight, preferably 5 to 20% by weight, of the blowing agent according to the invention. The premixes may consist of blowing agent and polyol, but also one or more of the above-mentioned auxiliaries and additives may be contained therein in an amount of from e.g. 10 to 30% by weight. Blowing agent, polyol and any auxiliaries and/or additives present add up to 100% by weight in the premix. Preferably polyether polyols or polyester polyols are used. For example 10 to 20% by weight, preferably 10 to 15% by weight, of a phosphorus compound, preferably triethyl phosphate or tris-chloroisopropyl phosphate, may be contained in the premix.

The production constituent or polyol premix according to the invention is then brought into contact with the isocyanate or isocyanates in known manner and foamed.

The polyols are compounds with at least 2 hydrogen atoms which are reactive with respect to isocyanates. These are in particular compounds with a molecular weight of from 400 to 10,000, which preferably contain 2 to 8 hydroxyl groups and furthermore may contain amino groups, thiol groups or carboxyl groups.

The premix according to the invention is even safer compared with known premixes with respect to being flameproof. Thus simple storage and transport of the premix is possible.

The invention additionally relates to synthetic resin foams produced using the blowing-agent mixture according to the invention.

The following examples are intended to illustrate the invention in further detail, without limiting its scope.

### EXAMPLES

### Example 1

### Polyol Mixture

A polyether polyol (Tercarol A350) was mixed with 10% by weight blowing agent (relative to the polyol) and the flashpoint was determined. A ternary mixture consisting of 80 parts by weight HFC-365mfc and HFC-227ea (weight ratio 87:13) and 20 parts by weight 1,1,1,3,3-pentafluoropropane was used as the blowing agent. The flashpoint according to DIN EN ISO 13736 was 15° C.

### Example 2

### Use of HFC-134a

A premix was produced analogously to Example 1 from polyether polyol (Tercarol A350) and 10% by weight ternary blowing-agent mixture. Instead of the fluoropropane, it contained HFC-134a. The flashpoint was determined in accordance with DIN EN ISO 13763. No flashpoint could be determined.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A blowing-agent mixture comprising:
A) 1,1,1,3,3-pentafluorobutane and
B) 1,1,1,2,3,3,3-heptafluoropropane, and
C) at least one of 1,1,1,2-tetrafluoroethane and 1,1,1,3,3-pentafluoropropane,
with the following provisos:
a) per 100 parts by weight of the blowing-agent mixture, 65 to 85 parts by weight are allotted to the total of constituents A) and B);
b) per 100 parts by weight of the total of the constituents A) and B) mentioned under a), 80 to 95 parts by weight are allotted to 1,1,1,3,3-pentafluorobutane, and the remainder of the total of A) and B) is 1,1,1,2,3,3,3-heptafluoropropane, and
c) per 100 parts by weight of the blowing-agent mixture, at least 15 parts by weight are allotted to constituent C).

2. A blowing agent mixture according to claim 1, which consists of constituents A), B) and C).

3. A blowing-agent mixture according to claim 2, wherein per 100 parts by weight of the blowing-agent mixture, 70 to 80 parts by weight being are allotted to the total of constituents A) and B) and 20 to 30 parts by weight to constituent C).

4. A production constituent for producing a synthetic resin foam, said constituent comprising from 1 to 35 percent by weight of a blowing-agent mixture according to claim 1, and the balance to 100% comprising synthetic resin foam auxiliaries and/or additives.

5. A production constituent according to claim 3, wherein said auxiliaries or additives comprise flameproofing agents or catalysts.

6. A non-combustible premix for producing a synthetic resin foam comprising:
at least one polyol selected from the group consisting of polyether polyols and polyester polyols; and
a blowing agent according to claim 1;
wherein said premix contains from 1 to 35% by weight of the blowing agent.

7. A premix according to claim 6, wherein said premix contains from 5 to 20% by weight of the blowing agent.

8. A synthetic resin foam produced by reacting a polyisocyanate and an isocyanate-reactive polyfunctional compound premix, wherein said pre-mix comprises a blowing-agent according to claim 1.

9. A method of producing a polyurethane resin foam product comprising:
forming a pre-mix comprising a compound having at least two hydrogen atoms which are reactive with isocyanate groups, a blowing agent and a catalyst, wherein said blowing agent comprises 1 to 35% by weight of said premix;
mixing the premix with a polyisocyanate having from 2 to 4 isocyanate groups to form a reaction mixture, and
allowing the reaction mixture to react to form a foamed polyurethane product;
wherein said blowing agent comprises:
A) 1,1,1,3,3-pentafluorobutane, and
B) 1,1,1,2,3,3,3-heptafluoropropane, and
C) at least one of 1,1,1,2-tetrafluoroethane and 1,1,1,3,3-pentafluoropropane,
with the following provisos:
a) per 100 parts by weight of the blowing-agent mixture, 65 to 85 parts by weight are allotted to the total of constituents A) and B);
b) per 100 parts by weight of the total of the constituents A) and B) mentioned under a), 80 to 95 parts by weight are allotted to 1,1,1,3,3-pentafluorobutane, and the remainder of the total of A) and B) is 1,1,1,2,3,3,3-heptafluoropropane, and
c) per 100 parts by weight of the blowing-agent mixture, at least 15 parts by weight are allotted to constituent C).

10. A method according to claim 9, wherein said compound having at least two hydrogen atoms which are reactive with isocyanate groups comprises a polyether, polyester, polycarbonate or polyester amide compound having a molecular weight of from 400 to 10,000 and containing 2 to 8 hydroxyl groups and optionally amino groups, thiol groups or carboxyl groups.

11. A method according to claim 10, wherein said compound is a polyester polyol or polyether polyol having from 2 to 8 hydroxy groups.

12. A method according to claim 9, wherein said polyisocyanate is an aliphatic, cycloaliphatic, aromatic or araliphatic polyisocyanate with an aliphatic hydrocarbon radical with up to 18 carbon atoms; a cycloaliphatic hydrocarbon radical with up to 15 carbon atoms; an aromatic hydrocarbon radical with 6 to 15 carbon atoms or an araliphatic hydrocarbon radical with 8 to 15 carbon atoms.

13. A method according to claim 12, wherein said polyisocyanate is selected from the group consisting of 2,4-toluene diisocyanate and 2,6-toluene diisocyanate, diphenylmethane diisocyanate, and polymethylene polyphenyl isocyanate.

14. A method according to claim 9, wherein said catalyst comprises an organic amine, an aminoalcohol, an aminoether, or an organometallic salt of tin, cobalt or iron and a carboxylic acid.

15. A method according to claim 9, wherein said premix further comprises at least one further auxiliary or additive selected from the group consisting of water, surface-active agents, emulsifiers, foam stabilizers, reaction-delaying agents, cell regulators, pigments, dyes, flameproofing agents, stabilizers against ageing or weathering, plasticisers, fillers, dyes, antistatic agents, nucleating agents, pore-regulating substances and biocidal active agents.

16. A method according to claim 9, wherein said premix comprises from 5 to 20% by weight of said blowing agent mixture.

17. A method of producing a thermoplastic foam comprising:
mixing a blowing agent with a molten thermoplastic synthetic resin to form an foamable mixture comprising from 1 to 35% by weight of the blowing agent, and
allowing the foamable mixture to foam and solidify to form a foamed synthetic resin product;
wherein said blowing agent comprises:
A) 1,1,1,3,3-pentafluorobutane, and
B) 1,1,1,2,3,3,3-heptafluoropropane, and
C) at least one of 1,1,1,2-tetrafluoroethane and 1,1,1,3,3-pentafluoropropane,
with the following provisos:
a) per 100 parts by weight of the blowing-agent mixture, 65 to 85 parts by weight are allotted to the total of constituents A) and B);
b) per 100 parts by weight of the total of the constituents A) and B) mentioned under a), 80 to 95 parts by weight are allotted to 1,1,1,3,3-pentafluorobutane, and the remainder of the total of A) and B) is 1,1,1,2,3,3,3-heptafluoropropane, and
c) per 100 parts by weight of the blowing-agent mixture, at least 15 parts by weight are allotted to constituent C).

18. A method according to claim 17, wherein said foamable mixture is directly extruded to form a foamed sheet, film or profile.

19. A method according to claim 17, wherein said thermoplastic synthetic resin comprises a polystyrene resin or a polyethylene resin.

20. A method according to claim 17, wherein said blowing agent comprises 80% by weight of a mixture of 87 parts by weight of 1,1,1,3,3-pentafluorobutane and 13 parts by weight of 1,1,1,2,3,3,3-heptafluoropropane; and 20% by weight of 1,1,1,3,3-pentafluoropropane, or 1,1,1,2-tetrafluoroethane, or a mixture of 1,1,1,3,3-pentafluoropropane and 1,1,1,2-tetrafluoroethane.
